(19) United States
(12) Patent Application Publication
(10) Pub. No.: US 2008/0003084 A1
(43) Pub. Date: Jan. 3, 2008

(54) High speed tray transfer system

(76) Inventors: Merlin E. Behnke, Meguon, WI (US); Rob G. Bertz, Wauwatosa, WI (US); Duane B. Jahnke, Hartford, WI (US); Ken J. Pikus, New Berlin, WI (US); Dave J. Rollmann, New Berlin, WI (US); Mark R. Shires, Glendale, WI (US); Todd K. Pichler, New Berlin, WI (US); Mike J. Reilly, Mukwonago, WI (US)

Correspondence Address: Mark Shires;c/o International Product Tech., 3100 S. 166th St., New Berlin, WI, 53151, US

(21) Appl. No.: 11/823,746

(22) Filed: Jun. 28, 2007

Related U.S. Application Data
(60) Provisional application No. 60/818,131, filed on Jun. 30, 2006.

(51) Int. Cl. B65G 1/00

(52) U.S. Cl. 414/331.18

(57) ABSTRACT

A high-speed tray transfer system for trays of semiconductor devices for increasing the rate at which trays are delivered to, and advanced through, a pick and place that moves orthogonal to the tray movement, so as to increase the overall throughput speed of a semiconductor handling machine. The invention utilizes two or more platens that carry trays. The platens can pass over, under or otherwise around each other so that while one platen is under and servicing the pick and place, another platen is cycling around and preparing another tray of electronic devices for the pick and place.

### CROSS REFERENCE TO RELATED APPLICATIONS

This application claims the benefit of provisional patent application Ser. No. 60/818,131 filed Jun. 30, 2006 by the present inventors.

### FEDERALLY SPONSORED RESEARCH

Not Applicable.

### SEQUENCE LISTING OR PROGRAM

Not Applicable.

### BACKGROUND

1. Field of the Invention

The electronics industry routinely transports semiconductor devices in trays consisting of an array of pockets. These trays provide safe and convenient handling of the devices. Typically these trays are feed into a machine for inspecting or testing or otherwise processing the devices. The present invention relates generally to tray transfer systems and more specifically it relates to tray transfer or delivery systems for trays of semiconductor devices for increasing the rate at which trays are supplied to a linear pick and place so as to increase the overall throughput speed of a semiconductor handling machine. The invention additionally improves the accuracy of tray positioning for improved pick and place functioning.

2. Prior Art

Tray transfer systems have been used on semiconductor processing machines for years. Typically, tray transfer systems utilize a single platen (tray holder) with a single tray delivery mechanism. For example, U.S. Pat. No. 6,266,873 to Kitamura (2001) shows a single tray moving mechanism.

Typical tray transfer systems position the tray under an orthogonally oriented linear pick and place which can then pick up each electronic device along one row of the tray. The tray is then indexed forward so that the pick and place can access the second row of devices. This continues until all rows are accessed by the pick and place. Then the tray transfer system removes the tray from the pick and place area, disposes of the tray, obtains a new tray and repeats the process.

The main problem with conventional tray transfer systems is that they slow down the overall throughput speed of a semiconductor handling machine because they are unable to continuously deliver trays, and thus semiconductor devices, to a linear pick and place for processing. There is down-time while the tray delivery mechanism removes the processed tray from the pick and place area, places the tray in an output destination, returns to a stack of new trays, picks up a new tray and finally delivers the new tray to the pick and place area so that the pick and place can continue picking and placing devices.

U.S. Pat. No. 6,941,647 to Cho (2005) discloses a two platen tray feeder in which each platen can alternately position successive trays in identical load and unload positions, but they cannot index row by row under a linear orthogonal pick and place. Additionally, even if the horizontal travel was increased to allow for such indexing, the tray platens do not travel in a circuit so that an index between the last row of one tray and the first row of a subsequent tray would not be as fast as an index from one row to the next row within a tray. But rather, substantial tray translation is required between the pick and place servicing the last row of one tray and then servicing the first row of the subsequent tray. This requires additional time and thus slows down the overall throughput of the machine.

Another problem with conventional tray transfer systems are that they are less accurate in positioning trays, and thus devices, under the pick and place, particularly in the vertical axis because they justify tray position based on the bottom surface of the tray instead of the top surface of the tray which is typically manufactured to tighter tolerances.

Another problem with conventional tray transfer systems is that trays are often bowed or warped and no accommodation is made for this. A warped tray can result in an unsuccessful pick up by the pick and place because some devices may be lower than others.

Another problem with conventional tray transfer systems is that they further slow down the overall throughput speed of a machine because they engage and release a tray clamp mechanism every time a tray is indexed underneath the pick and place. This action consumes valuable time because it cannot be performed in parallel with tray indexing or with pick and place processing.

### SUMMARY OF THE INVENTION

The present invention provides a new high-speed tray transfer module for trays of semiconductor devices for increasing the rate at which trays are delivered to and advanced through a pick and place so as to increase the overall throughput speed of a semiconductor handling machine. In brief, the invention utilizes 2 independently operable platens that can pass over, under or otherwise around each other so that while one platen is under the pick and place, the other platen is cycling around and preparing another tray for the pick and place.

The present invention generally comprises a tray loader, two independent horizontal tray mover assemblies, two independent vertical tray mover assemblies, a tray unloader, and an electronic controller for controlling the operation of each assembly.

A primary object of the present invention is to provide a high-speed tray transfer system that can continuously deliver trays to a pick and place without interruption so as to increase the overall throughput speed of a semiconductor handling machine. A second object is to more quickly index a tray, row by row, underneath a pick and place by eliminating multiple tray clamping operations so as to increase the overall throughput speed of a semiconductor handling machine. A third object of the invention is to more accurately and repeatably position devices in trays vertically by justifying the tray position from the top of the tray for more reliable picking and placing. A fourth object is to flatten bowed trays as they are presented to a pick and place to increase the consistency of the vertical location of tray pockets so that the pick and place can more quickly and reliably pick and place devices into or out of trays.

### BRIEF DESCRIPTION OF THE DRAWINGS

FIG. 1 is an isometric view of the entire high speed tray transfer system.

FIG. 2 is an isometric view of the tray loader.

FIG. 3a is an isometric view showing the vertical tray mover.

FIG. 3b is a different angle isometric view of FIG. 3.

FIG. 4 is an isometric view of the two vertical tray movers attached to their respective horizontal tray movers.

### DETAILED DESCRIPTION OF THE INVENTION

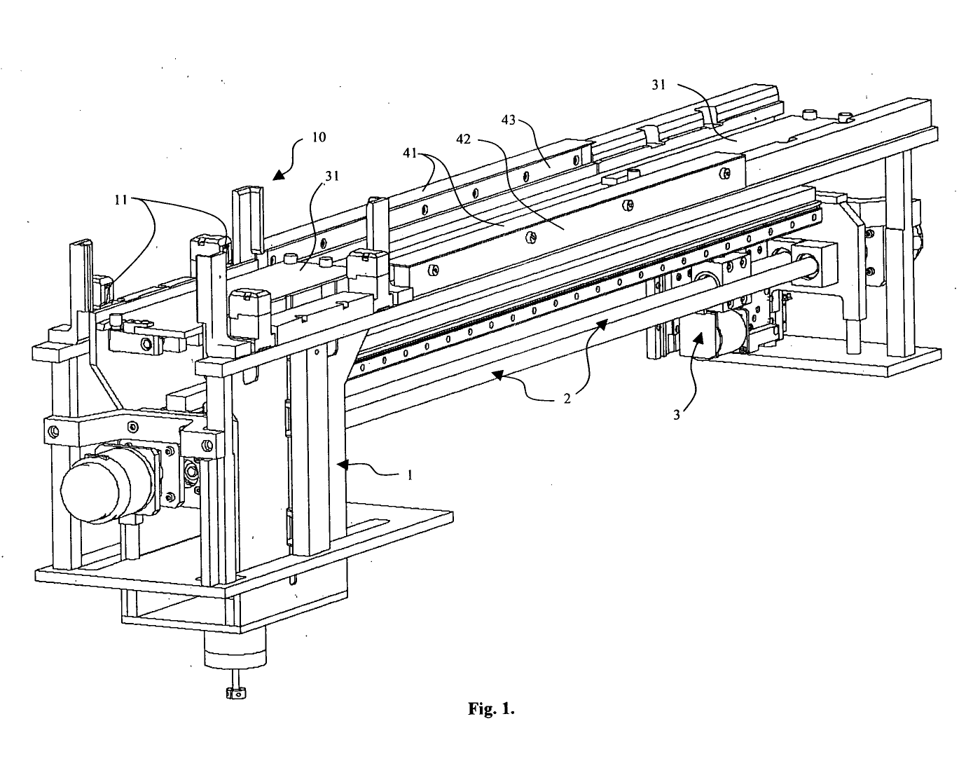

FIG. 1 illustrates the invention. It comprises a tray loader 1, two independent horizontal mover assemblies 2, two independent vertical tray mover assemblies 3 with platens 31, a tray unloader (not shown), and an electronic controller for controlling the operation of each assembly (not shown).

The tray loader 1 can hold a stack of trays, and lower the bottom tray onto a platen one at a time. The stack of trays are placed within four vertical bars 10 that are positioned to capture the corners of the trays. The stack of trays are supported on the bottom by four tray holder fingers 11.

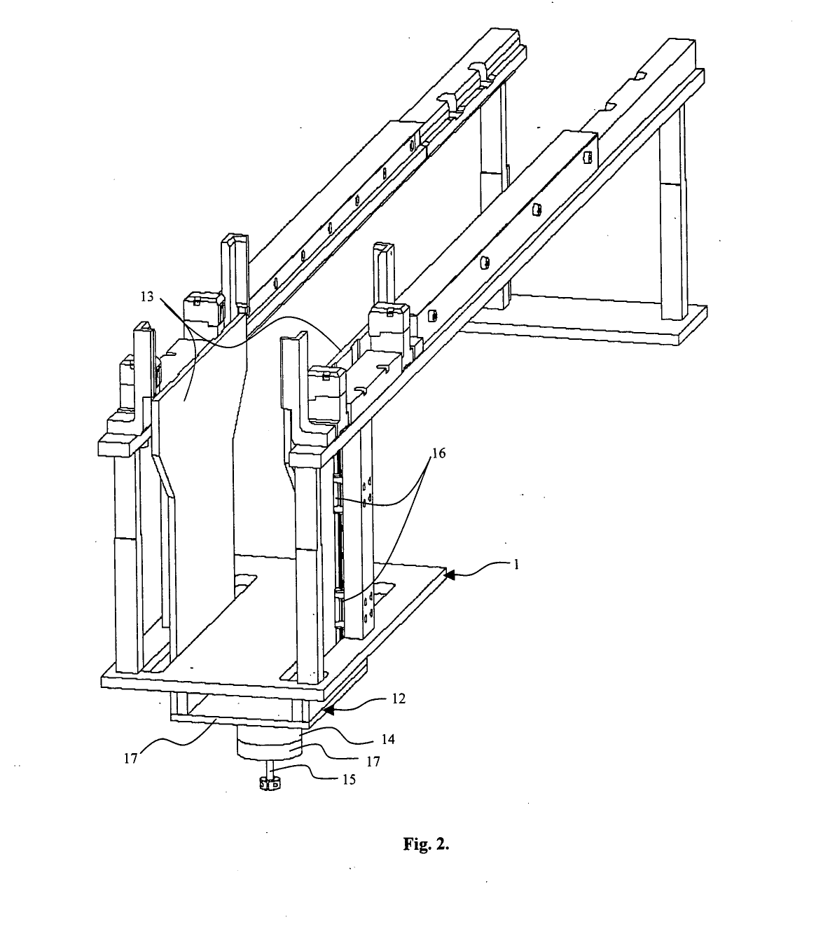

FIG. 2 shows elevator assembly 12 which can lift the stack of trays by raising or lowering the elevator plates 13 that are connected on the bottom via a horizontal plate 17. These elevator plates straddle other components (see FIG. 1). These plates can move up or down via an electric motor 14 connected to a screw drive 15. The elevator plates are each attached to linear bearings 16. In operation, the elevator plates 13 are moved upward until they contact the bottom of the stack of trays. From this position the elevator plates move slightly higher and thus slightly raise the entire stack of trays. The tray holder fingers 11 are now retracted. Next the elevator plates 13 are moved downward by a distance approximately equal to the thickness of a tray. The tray holder fingers 11 are then extended between the lowest and second lowest tray. As the elevator plates move further down, the tray that was second from the bottom of the stack comes to rest on the tray holder fingers. In this way a single tray is removed from the bottom of the stack of trays. Then the elevator plates 11 continue to lower the tray until it rests on a platen 31 (a flat plate that a tray can rest on).

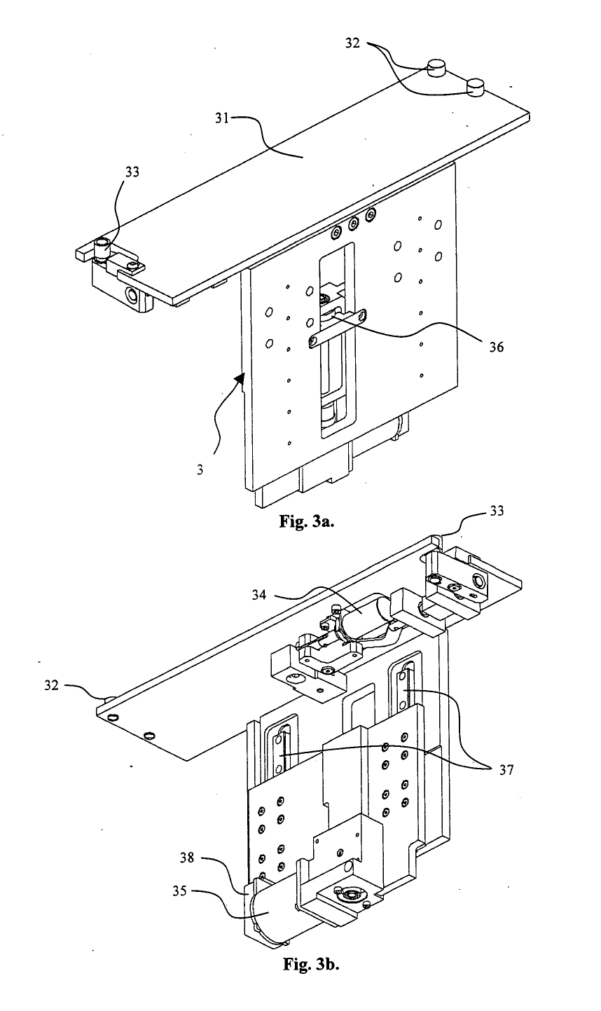

Each platen 31 is connected to a vertical tray mover assembly 3 as seen in FIGS. 3a and 3b. Once a tray is resting on the platen it is clamped in place. The tray clamps are mechanisms on the platens that hold a tray in place on the platen. In a preferred embodiment they consist of two stationary pins 32 on one end of the platen and a movable pin 33 on the other end. This movable pin is activated on demand by a solenoid 34 (FIG. 3b) or other actuator and can move toward and away from the stationary pins. The vertical tray mover is a mechanism that can move the platen, and thus the tray, vertically. It employs an electric motor 35, connected to a screw drive 36 via a pair of bevel gears to achieve the up and down motion. Linear bearings 37 guide the vertical movement.

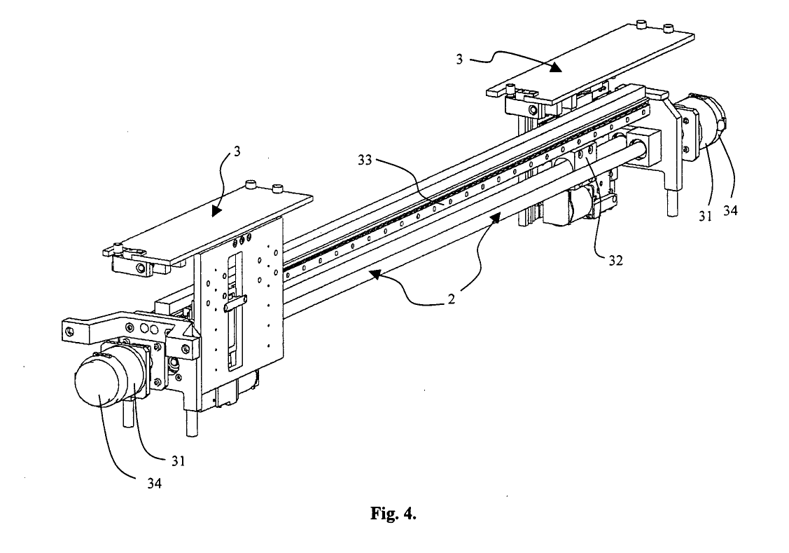

The horizontal tray mover 2 is a mechanism that horizontally moves a vertical tray mover 3 as seen in FIG. 4. In a preferred embodiment this consists of a high-speed electric motor 31 driven screw drive 32 and linear bearing 33 with structural members that support the vertical tray mover. Activating the motor and thus turning the screw causes the horizontal tray mover to move horizontally. Bearing 33 guides the horizontal motion and bears the weight of the attached assemblies. Various alternate actuators could be used for the horizontal tray mover. The horizontal tray mover is attached to the housing of the high-speed transfer system. There are two of these assemblies in the housing; a left hand version and a right hand version. They are oriented 180 degrees rotated from each other so that the platens of each unit can pass above or below each other as they cycle through the same path in a clockwise or counter-clockwise fashion.

Precise positional information about of each horizontal tray mover is provided by encoder 34. Likewise, feedback regarding the location of each vertical tray mover is provided by encoder 38 (FIG. 3b). The elevator positional information is provided by encoder 17 (FIG. 2). These encoders allow the electronic controller to precisely position these movers. These are optical rotary encoders connected to the motor shafts. Alternatively, linear encoders could be used. Non-optical encoders could be used also.

During operation, once a tray has been placed on a platen, the horizontal mover moves the tray away from the tray loader. The tray is thus feed between horizontal rails 42 and 43 (see FIG. 1). Rail 43 is spring loaded so as to apply pressure to push the tray against rail 42. In this way the tray is laterally justified against rail 42. When the tray has moved far enough to be clear of the loader mechanisms, the vertical tray mover moves the tray upward until the top surface of the tray contacts the vertical tray limit rails 41. The servomotor on the vertical tray mover can change from position mode to torque mode. Thus the motor moves the platen vertically until it experiences a specific force against it. In this way the force exerted upon the tray can be used to flatten warped trays. Additionally, the tray location is thus justified from the top of the tray for greatest vertical positional accuracy of devices. Now the tray can be horizontally indexed underneath the pick and place by means of the horizontal tray mover. The method of tray clamping does not require any additional clamping or unclamping while this platen is providing devices to the pick and place. Therefore the index time is minimized. Meanwhile, the other platen delivers its tray to the end of the tray transfer system where a tray unloader can process it. One embodiment utilizes another instance of the tray delivery system operated in reverse and thus stacks up used trays. This now empty platen can move downward via the vertical tray mover, until it is lower than the platen that is currently servicing the pick and place. Then the platen moves back to the tray delivery system by passing underneath the other platen. The platen obtains a new tray of devices and is queued behind the platen servicing the pick and place, so that as soon as the pick and place is finished with the current tray, a tray full of new devices can be immediately delivered.

By having these mechanisms cycle around in a somewhat circular fashion, this high-speed tray transfer system is able to continuously feed trays to the pick and place without any interruption. It should be obvious that various actuators could be used and still remain within the scope of this invention. Various alternative structures could produce the same effect of having two or more platens that can pass each other. For example, if the platens tilted or pivoted they could pass each other also.

What is claimed is:

1. A high-speed tray transfer system for trays of semiconductor devices for increasing the rate at which trays are delivered to a pick and place so as to increase the overall throughput speed of a semiconductor handling machine, said tray transfer system comprising:
a) a tray loader with tray singulating means for taking a single tray from a stack of trays and putting it on a platen,
b) two subassemblies, each comprising:
a) a platen for holding a tray,
b) a horizontal bearing to allow said platen to move horizontally,
c) an actuator for propelling said platen horizontally,
d) an actuator for moving or tilting said platen in a non-horizontal direction,
c) a tray unloading means to remove said trays from said platens,
d) an electronic controller means to control the actuators and thus the movement and operation of said platens such that said platen of one subassembly can pass above or below or otherwise around said platen of the other said subassembly so that subsequent trays can traverse the same path.

2. The high-speed tray transfer system of claim 1 wherein said actuator for moving or tilting said platen in a non-horizontal direction moves platen in a substantially vertical direction.

3. The high-speed tray transfer system of claim 1 which additionally comprises horizontal rails wherein said actuator for moving or tilting said platen in a non-horizontal direction moves platen in a vertical direction so as to press trays upwards against said horizontal rails with a force able to flatten trays that are warped.

4. A method of delivering trays to a pick and place utilizing two tray delivery systems, the method comprising:
a) placing a tray on a first platen and delivering the tray to the pick and place,
b) indexing first platen under said pick and place so that pick and place can access each row of said tray on first platen,
c) placing a tray on a second platen and staging the platen immediately behind first platen while first platen is indexing under said pick and place,
d) moving first platen from said pick and place after processing is complete,
e) delivering the tray on second platen to said pick and place,
f) indexing second platen under said pick and place so that pick and place can access each row of said tray on second platen,
g) disposing of said tray on first platen while second platen is indexing under said pick and place,
h) then moving first platen under or beside second platen and returning to a tray receiving position to receive another tray,
i) placing a tray on first platen and staging first platen immediately behind second platen,
j) moving second platen from said pick and place after processing is complete,
k) disposing of said tray on second platen,
l) returning second platen to a tray receiving position by going under or beside first platen.

5. The method of claim 4 that further comprises clamping each said tray to a platen exactly once.

6. The method of claim 4 in which all trays travel through the same path from being placed on a platen to indexing under said pick and place.

7. A high-speed tray transfer system for trays of semiconductor devices for increasing the rate at which trays are delivered to, and indexed through, a pick and place so as to increase the overall throughput speed of a semiconductor handling machine, said tray transfer system comprising:
a) a tray loader with tray singulating means for releasing a single tray from a stack of trays and putting it on a platen,
b) two subassemblies, each comprising:
a) a platen for transporting a tray,
b) a tray clamping means to temporarily secure a tray to said platen, said tray clamping means being affixed to said platen,
c) an actuator for engaging and releasing said tray clamping means,
d) a horizontal bearing to allow said platen to move horizontally,
e) an actuator for propelling said platen horizontally,
f) a positional encoder for determining the horizontal position of said platen,
g) a vertical bearing to allow said platen to move vertically,
h) an actuator for propelling said platen vertically,
i) a positional encoder for determining the vertical position of said platen,
c) an electronic controller means to control the actuators and thus the movement and operation of said platens such that said platen of one subassembly can pass above or below or otherwise around said platen of the other said subassembly and whereby the platens can cycle subsequent trays of semiconductor devices to travel through an identical path.

8. The high-speed tray transfer system of claim 7 which additionally comprises a stationary horizontal rail and a spring loaded horizontal rail so that a tray on said platen is precisely positioned to be justified against the stationary rail.

9. The high-speed tray transfer system of claim 7 wherein said tray loader additionally comprises:
a) retractable tray holder fingers that engage in slots between a stack of trays,
b) actuators for retracting said tray holder fingers,
c) stationary locating features to confine the position of a stack of trays,
d) a vertical elevator assembly means to lift and lower the stack of trays.

10. The high-speed tray transfer system of claim 7 which additionally comprises an elevator means for raising and lowering trays in the stack fixture.
